(19) United States
(12) Patent Application Publication
(10) Pub. No.: US 2023/0134440 A1
(43) Pub. Date: May 4, 2023

(54) RESIN-COATED PETROLEUM COKE AS PROPPANT PARTICULATE MATERIAL AND METHODS RELATED THERETO

(71) Applicant: ExxonMobil Upstream Research Company, Spring, TX (US)

(72) Inventors: Kendal DECKER, Spring, TX (US); Dragan STOJKOVIC, Spring, TX (US); Lee J. HALL, The Woodlands, TX (US)

(21) Appl. No.: 18/047,383

(22) Filed: Oct. 18, 2022

Related U.S. Application Data
(60) Provisional application No. 63/263,394, filed on Nov. 2, 2021.

(51) Int. Cl. C09K 8/80

(52) U.S. Cl. CPC C09K 8/805

(57) ABSTRACT

Proppant particulates like sand are commonly used in hydraulic fracturing operations to maintain one or more fractures in an opened state following the release of hydraulic pressure. Fracturing fluids and methods of hydraulic fracturing may also use proppant particulates composed of resin-coated petroleum coke (referred to as resin-coated petroleum coke proppant particulates). In some instances, the resin-coated petroleum coke proppant particulates have a particle density of equal to or less than about 1.7 grams per cubic centimeter and better resistance to creating fines when exposed to uniaxial stress.

### CROSS-REFERENCE TO RELATED APPLICATION

This application claims the benefit of U.S. Provisional Application Ser. No. 63/263,394, entitled “Resin-Coated Petroleum Coke as Proppant Particulate Material and Methods Related Thereto,” filed Nov. 2, 2021, the disclosure of which is hereby incorporated by reference in its entirety.

### FIELD OF THE INVENTION

This application relates to fracturing operations, and, in particular, to proppant particulates formed from petroleum coke material, and methods related thereto.

### BACKGROUND OF THE INVENTION

A wellbore may be drilled into a subterranean formation in order to promote removal (production) of a hydrocarbon or water resource therefrom. In many cases, the subterranean formation needs to be stimulated in some manner in order to promote removal of the resource. Stimulation operations may include any operation performed upon the matrix of a subterranean reservoirs (e.g., shale or loose sandstone).

Hydraulic fracturing operations pump large quantities of fluid into a subterranean formation (e.g., a low-permeability formation) under high hydraulic pressure to promote formation of one or more fractures within the matrix of the subterranean formation and create high-conductivity flow paths. Primary fractures extending from the wellbore and, in some instances, secondary fractures extending from the primary fractures, possibly dendritically, may be formed during a fracturing operation. These fractures may be vertical, horizontal, or a combination of directions forming a tortuous path.

Proppant particulates are often included in a fracturing fluid in order to keep the fractures open after the hydraulic pressure has been released following a hydraulic fracturing operation. Upon reaching the fractures, the proppant particulates settle therein to form a proppant pack to prevent the fractures from closing once the hydraulic pressure has been released. Accordingly, increasing the propped area within hydraulically induced fractures is a key factor for enhancing resource production.

There are oftentimes difficulties encountered during hydraulic fracturing operations, particularly associated with deposition of proppant particulates in fractures that have been created or extended under hydraulic pressure. Because proppant particulates are often fairly dense materials, effective transport of the proppant particulates may be difficult due to settling, making it challenging to distribute the proppant particulates into more remote reaches of a network of fractures. In addition, fine-grained particles (referred to as “fines”) produced from crushing of proppant particulates within the fractures can also lessen fluid conductivity, which may decrease production rates and/or necessitate wellbore cleanout operations.

### SUMMARY OF THE INVENTION

This application relates to fracturing operations, and, in particular, to proppant particulates formed from petroleum coke material, and methods related thereto.

In nonlimiting aspects of the present disclosure, a proppant particulate is provided having a petroleum coke particle composed of fluid coke or flexicoke; and a resin coating at least a portion of the petroleum coke particle.

In nonlimiting aspects of the present disclosure, a fracturing fluid is provided including a carrier fluid; and proppant particulates comprising a petroleum coke particle composed of fluid coke or flexicoke and a resin coating at least a portion of the petroleum coke particle.

In nonlimiting aspects of the present disclosure, a method is provided including introducing a fracturing fluid into a subterranean formation, the fracturing fluid including a carrier fluid; and proppant particulates comprising a petroleum coke particle and a resin coating at least a portion of the petroleum coke particle.

These and other features and attributes of the disclosed petroleum coke proppant particulates of the present disclosure and their advantageous applications and/or uses will be apparent from the detailed description which follows.

### DETAILED DESCRIPTION

This application relates to fracturing operations, and, in particular, to proppant particulates formed from petroleum coke material, and methods related thereto.

As discussed above, proppant particulates can be used effectively during fracturing operations, but there may be issues associated with their use. First, the high densities of typical proppant particulates (e.g., sand having an apparent density of about 2.65 grams per cubic centimeter (g/cc)) may hinder their transport, possibly leading to inadequate proppant particulate disposition within one or a plurality of fractures. Second, some proppant particulates are prone to fines formation due to low crush strength values, which may lead to decreased fracture conductivity due to fines accumulation within a wellbore.

One way to produce a larger propped area is to use lighter proppant that will stay suspended in a low viscosity fluid longer while being hydraulically transported further into a fracture than other higher density proppants. Ultralight proppant, with density very close to the density of slickwater, a low viscosity fluid, for example, will stay suspended therein much longer compared to higher density traditional (e.g., sand) proppant particulates, and with small variations in density can even settle both toward the bottom and the top of the fracture. However, lighter density materials usually have less compressive strength to sustain the fracture opening permanently after fracture closure. Available ultra-light proppant options are either much more expensive than traditional proppant particulates, or have a comparably significantly lower compressive strength and hydraulic conductivities.

The present disclosure alleviates the foregoing difficulties and provides related advantages as well. In particular, the present disclosure describes low density proppant particulates composed of a resin-coated petroleum coke material, such as fluid coke and/or flexicoke. The low density petroleum coke proppant particulates described herein can be effectively suspended in a low viscosity carrier fluid (e.g., slickwater) and delivered at a high flow rate into a wellbore for fracturing operations and further exhibit high crush strengths, particularly when resin-coated, thereby addressing two shortcomings of traditional proppant particulates. It is to be understood that the term “petroleum coke,” as used herein, refers to both fluid coke and flexicoke, unless otherwise stated for ease of description. Accordingly, the “petroleum coke” of the present disclosure is distinguished from delayed coke and other types of coke that have very different properties and are not considered suitable for use as a proppant material, as described hereinbelow.

Typically, fluid coke and flexicoke are used as a fuel source in various manufacturing processes for heat. However, fluid coke and flexicoke are usually a lower BTU source, compared to traditional coke. By using fluid coke and/or flexicoke as proppant particulate material, overall CO₂ emissions are reduced. In effect, using the resin-coated petroleum coke proppant particulates described herein is a form of sequestering carbon that would otherwise contribute to CO₂ emissions.

Moreover, as described in greater detail herein below, the resin-coated petroleum coke proppant particulates for use in fracturing operations of the present disclosure can additionally allow for extended propped fractures due to their low density and reduced costs of the fracturing operation (e.g., lower pumping pressure, reduced equipment erosion, reduced viscosifier loadings, reduced rate requirements and the like).

Fluid coking is a carbon rejection process that is used for upgrading heavy hydrocarbon feeds and/or feeds that are challenging to process. The process produces a variety of lighter, more valuable liquid hydrocarbon products, as well as a substantial amount of fluid coke as byproduct. The fluid coke byproduct comprises high carbon content and various impurities. The fluid coking process may be manipulated to obtain fluid coke having the distinctive characteristics described herein that are suitable for use as proppant particulate material, including as a supplement or replacement to traditional proppant particulate material.

Flexicoke is produced from a modified variation of fluid coking, termed FLEXICOKING™ (trademark of ExxonMobil Research and Engineering Company (“ExxonMobil”)). FLEXICOKING™ is based on fluidized bed technology developed by ExxonMobil, and is a carbon rejection process that is used for upgrading heavy hydrocarbon feeds (referred to as “residual”). Unlike fluid coking, which utilizes a reactor and a burner, the FLEXICOKING™ process uses a reactor, a heater, and a gasifier. The FLEXICOKING™ process is described in greater detail below.

Illustrative petroleum coke (including either or both of fluid coke or flexicoke) proppant particulates of the present disclosure are resin-coated to maintain desired compressive strength and may have, among other characteristics, an particle density of equal to or less than 1.7 g/cc, and are suitable for inclusion in a carrier fluid for use during a fracturing operation within a horizontal, vertical, or tortuous wellbore, including hydrocarbon-bearing production wellbores and water-bearing production wellbores.

As used herein, the term “proppant particulate,” and grammatical variants thereof, refers to a solid material capable of maintaining open an induced fracture during and following a hydraulic fracturing treatment. The term “proppant pack,” and grammatical variants thereof, refers to a collection of proppant particulates.

As used herein, the term “fracturing fluid” refers to a chemical mixture comprising a flowable carrier fluid, proppant particulates, and one or more optional additives.

As used herein, the term “pre-pad” refers to a practice of pumping water without proppant as first part of the pumping design in a stage.

As used herein, the term “particle density,” with reference to the density of proppant particulates, refers to the density of the individual particulates themselves, which may be expressed in grams per cubic centimeter (g/cm³). The particle density values of the present disclosure are based on the American Petroleum Institute's Recommended Practice 19C (hereinafter “API RP-19C”) standard entitled “Measurement of Properties of Proppants Used in Hydraulic Fracturing and Gravel-packing Operations” (First Ed. May 2008, Reaffirmed June 2016). Particle density is also referred to as specific gravity in the industry.

As used herein, D50 is primarily used to describe particle sizes. As used herein, the term “D50” refers to a diameter at which 50% of the sample (on a volume basis unless otherwise specified) is comprised of particles having a diameter less than said diameter value. Particle size can be determined by sieving analysis, light scattering techniques, or analysis of optical digital micrographs. Unless otherwise specified, sieving analysis is used for analyzing particle size.

As used herein, the term “crush strength” or “compressive strength,” and grammatical variants thereof, with reference to proppant particulates, refers to the uniaxial stress (compressive) load proppant particulates can withstand prior to crushing (e.g., breaking or cracking). The crush strength values of the present disclosure are based on API RP-19C.

As used herein, the term “petroleum coke,” and grammatical variants thereof, refers to fluid coke or flexicoke, and is used herein to represent both unless otherwise indicated. The petroleum coke described herein is used as a low density, resin-coated proppant particulate material for forming a proppant pack during a fracturing operation. The term “petroleum coke proppant particulate material” refers to proppant packing material composed of fluid coke or flexicoke, and is used interchangeably with the term “petroleum coke proppant particulates.”

As used herein, the term “fluid coke,” and grammatical variants thereof, refers to the solid concentrated carbon material remaining from fluid coking. The term “fluid coking” refers to a thermal cracking process utilizing fluidized solids for the conversion of heavy, low-grade hydrocarbon feeds into lighter products (e.g., upgraded hydrocarbons), producing fluid coke as a byproduct. The term “fluid coke proppant packing material” refers to proppant packing material composed of fluid coke, and is used interchangeably with the term “fluid coke proppant particulates.”

The fluid coke proppant packing material described herein may have a carbon content of 75 weight percent (wt %) to 93 wt %, or 78 wt % to 90 wt %; a weight ratio of carbon to hydrogen of 30:1 to 50:1, or 35:1 to 45:1; an impurities content (weight percent of all components other than carbon and hydrogen) of 5 wt % to 25 wt %, or 10 wt % to 20 wt %; a sulfur content of 3 wt % to 10 wt %, or 4 wt % to 7 wt %; and a nitrogen content of 0.5 wt % to 3 wt %, or 1 wt % to 2 wt %, each encompassing any value and subset therebetween.

As used herein, the term “flexicoke” refers to the solid concentrated carbon material produced from FLEXICOKING™. The term “FLEXICOKING™” refers to a thermal cracking process utilizing fluidized solids and gasification for the conversion of heavy, low-grade hydrocarbon feeds into lighter hydrocarbon products (e.g., upgraded, more valuable hydrocarbons). The term “flexicoke proppant packing material” refers to proppant packing material composed of flexicoke (i.e., partially gasified fluid coke), and is used interchangeably with the term “flexicoke proppant particulates.”

Briefly, the FLEXICOKING™ process in which the flexicoke for forming the flexicoke proppant packing material described herein, integrates a cracking reactor, a heater, and a gasifier into a common fluidized-solids (coke) circulating system. A feed stream (of residua) is fed into a fluidized bed, along with a stream of hot recirculating material to the reactor. From the reactor, a stream containing coke is circulated to the heater vessel, where it is heated. The hot coke stream is sent from the heater to the gasifier, where it reacts with air and steam. The gasifier product gas, referred to as coke gas, containing entrained coke particles, is returned to the heater and cooled by cold coke from the reactor to provide a portion of the reactor heat requirement, which is typically about 496° C. to about 538° C. A return stream of coke sent from the gasifier to the heater provides the remainder of the heat requirement. The coke meeting the heat requirement is then circulated to the reactor and the feed stream is thermally cracked to produce light hydrocarbon liquids that are removed from the reactor and recovered using conventional fractionating equipment. Fluid coke is formed from the thermal cracking process and settles (deposits) onto the “seed” fluidized bed coke already present in the reactor — the resultant at least partially gasified coke is flexicoke. In some instances, the coke from the thermal cracking process deposits in a pattern that appears ring-like atop the surface of the seed coke. Flexicoke is continuously withdrawn from the system during normal FLEXICOKING™ processing (e.g., from the reactor or after it is streamed to the heater via an elutriator) to ensure that the system maintains particles of coke in a fluidizable particle size range. Accordingly, flexicoke is a readily available byproduct of the FLEXICOKING™ process.

The flexicoke gravel packing material described herein may have a carbon content of 85 wt % to 99 wt %, or 90 wt % to 96 wt %; a weight ratio of carbon to hydrogen of 80:1 to 98:1, or 85:1 to 95:1; an impurities content (weight percent of all components other than carbon and hydrogen) of 1 wt % to 15 wt %, or 3 wt % to 10 wt %; a combined vanadium and nickel content of 3000 ppm to 45,000 ppm, or 3000 ppm to 15,000 ppm, or 5000 ppm to 30,000 ppm, or 30,000 ppm to 45,000 ppm; a sulfur content of 0 wt % to 5 wt %, or 0.5 wt % to 4 wt %; and a nitrogen content of 0 wt % to 3 wt %, or 0.1 wt % to 2 wt %, each encompassing any value and subset therebetween.

As used herein, the term “resin,” and grammatical variants thereof, refers to a solid or viscous substance of plant or synthetic origin that can be converted to polymers capable of adhering to a petroleum coke proppant particulate to form the “resin-coated petroleum coke proppant particulates” of the present disclosure. The resin-coating can provide crush strength to the petroleum coke proppant particulates, inhibit degradation, prevent flowback, and reach extended fracture areas, among other functions.

As used herein, the term “coat,” and grammatical variants thereof, with reference to the resin-coated petroleum coke proppant particulates of the present disclosure, refers to complete or partial coating about a petroleum coke proppant particulate, encompassing surface coating of the petroleum coke proppant particulates (e.g., dispersion coating), embedment coating within pores of the petroleum coke proppant particulates, and any combination thereof (e.g., embedment and surface coating). That is, the coating needn't cover the entirety of the surface of the petroleum coke proppant particulate. The extent of coating results in a resin-coated petroleum coke proppant particulate having a particle density of equal to or less than 1.7 g/cc.

As used herein, the term “carrier fluid,” and grammatical variants thereof, refers to a fluid used to transport proppant particulates into a wellbore and fracture therein, which may include various additives, without departing from the scope of the present disclosure, and as would be apparent by one of ordinary skill in the art in light of the present disclosure.

As used herein, the term “fracture conductivity” refers to the permeability of a proppant pack to conduct fluid at various stress (pressure) levels. The fracture conductivity values of the present disclosure are based on the American Petroleum Institute's Recommended Practice 19D (API RP-19D) standard entitled “Measuring the Long-Term Conductivity of Proppants” (First Ed. May 2008, Reaffirmed May 2015).

All numerical values within the detailed description and the claims herein are modified by “about” or “approximately” with respect to the indicated value, and take into account experimental error and variations that would be expected by a person having ordinary skill in the art.

As used in the present disclosure and claims, the singular forms “a,” “an,” and “the” include plural forms unless the context clearly dictates otherwise.

The term “and/or” as used in a phrase such as “A and/or B” herein is intended to include “A and B,” “A or B,” “A,” and “B.”

### Resin-Coated Petroleum Coke Proppant Particulates, Methods and Systems

Hydraulic fracturing operations require effective proppant particulates to maintain the permeability and conductivity of a production well, such as for effective hydrocarbon recovery. Effective proppant particulates are typically associated with a variety of particular characteristics or properties, including efficient proppant particulate transport within a carrier fluid, sufficient compressive strength to maintain fractures propped upon the removal of hydraulic pressure, and efficient conductivity once the wellbore is brought on production.

The rate of settling of a proppant particulate within a fracturing fluid at least in part determines its transport capacity within one or more fractures created during a hydraulic fracturing operation. The rate of settling of a proppant particulate may be determined using Equation 1:

$$v = \frac{{ρ}_{p} - {ρ}_{f}}{18 η} g {σ}^{2} , \qquad Equation 1$$

where v is the terminal velocity of the proppant particle; πₚ−ρ_{f} is proportional to the density difference between the proppant particle and the carrier fluid; η is the viscosity of the carrier fluid; g is the gravitational constant; and σ² is proportional to the square of the proppant particulate diameter. As will be appreciated, proppant particulates having lower particle densities and/or smaller average particle sizes settle at a slower rate within an identical carrier fluid (thus having better transport) compared to higher particle density and/or larger average particle sized proppant particulates.

A proppant particulate's crush strength is a measure of its ability to withstand compressive stresses within a fracture, as they must resist sustained loads within a fractured subterranean formation during the lifetime of a wellbore to maintain its conductivity. Proppant particulates that are not able to withstand the imposed stresses of a fracture will crush over time, resulting in the formation of fines that may be transported into the wellbore and through equipment with produced fluids and accumulate in sufficient quantities to decrease production rates and/or necessitate costly wellbore cleanout operations or equipment replacement. Accordingly, proppant particulates with higher crush strengths are favorable. Such higher strength proppant, particulates would additionally serve to promote fracture conductivity, particularly under increasing stresses. According to API RP-19C standards, adequate proppant particulates should have a crush strength in which less than 10% of fines are produced under a stress of 5000 psi. As provided herein, adequate proppant particulates are evaluated against a minimum standard of 10 millidarcy-foot (mD-ft) to 30 mD-ft hydraulic conductivity under a uniaxial stress of 8000 psi.

Proppant particulate efficacy is further related to fracture conductivity, characterized by the fluid flow rate in a propped fracture under gradient pressure, the fracture being propped by a proppant pack. Fracture conductivity, C_{f}, is the product of the proppant pack permeability, k, and its thickness, h, and may be determined using Equations 2 and 3:

$${C}_{f} = kh , \qquad Equation 2$$

$$k = \frac{1}{C} \frac{{ϕ}^{3}}{{( 1 - ϕ )}^{2}} {σ}_{eff}^{2} {Φ}_{s}^{2} , \qquad Equation 3$$

where C is a constant; Φ is the proppant pack void fraction; σ is the average particle size diameter of the proppant particulates; and Φ is a shape factor related to the asphericity of the proppant particulates. In tension with settling rate and transport, fracture conductivity favors proppant particulates having larger average particle size diameters, as well as thick proppant packs and narrow particle size distribution.

Accordingly the conductivity of a proppant pack is dependent at least in part on the shape of the proppant particulates. In particular, proppant particulates having a substantially consistent spherical shape may provide increased porosity through which produced fluids may flow while maintaining the fracture(s) in a propped state. Moreover, proppant particulates having a relatively narrow size distribution may additionally be preferred to maintain the flow path within the proppant pack, such that smaller (or irregular shaped) proppant particulates do not fill voids within the proppant pack.

The Krumbein Chart provides an analytical tool to standardize visual assessment of the sphericity and roundness of proppant particulates. Each of sphericity and roundness is visually assessed on a scale of 0 to 1, with higher values of sphericity corresponding to a more spherical particle and higher values of roundness corresponding to less angular contours on a particle's surface. According to API RP-19C standards, the shape of a proppant particulate is considered adequate for use in fracturing operations if the Krumbein value for both sphericity and roundness is ≥0.6.

The resin-coated petroleum coke proppant particulates having the characteristics described herein exhibit the aforementioned properties, as well as others, which make them not only a viable alternative for traditional proppant particulates, but further a surprising substitute with enhanced functionality.

The resin-coated petroleum coke proppant particulates described herein are composed of an inner petroleum coke particle coated with a resin. The inner petroleum coke particle may have and particle density of less than 1.7 g/cc, including in the range of 1.4 g/cc to 1.7 g/cc, such as 1.4 g/cc to 1.6 g/cc, or 1.4 g/cc to 1.5 g/cc, or 1.5 g/cc to 1.6 g/cc, or 1.5 g/cc to 1.7 g/cc, or 1.6 g/cc to 1.7 g/cc, encompassing any value and subset therebetween. As provided above, traditional proppant particulates generally have particle densities greater than about 2.5 g/cc. Thus, the petroleum coke proppant particulates described herein have substantially lesser particle densities compared to traditional proppant particulates, which is indicative of their comparably more effective transport and lower settling rates within a carrier fluid used as part of a fracturing operation.

Generally, fluid and flexicoke petroleum coke proppant particulates (uncoated) have an average diameter (D50) in the range of 65 μm to 600 μm, such as 65 μm to 450 μm, or 65 μm to 350, or 65 μm to 250 μm, or 65 μm to 150 μm, or 150 μm to 550 μm, or 250 μm to 550 μm, or 350 μm to 550 μm, or 450 μm to 550 μm, encompassing any value and subset therebetween. In one or more aspects, the petroleum coke proppant particulates (uncoated) have an average sieve distribution (diameter) from 230 mesh to 30 mesh, or 200 mesh to 50 mesh, or 150 mesh to 100 mesh, encompassing any value and subset therebetween. In some aspects, a smaller petroleum coke proppant particulate (e.g., 100 μm to 200 μm, or 70 to 140 mesh) average diameter may be desirable in order to reach far-field areas of fractures for more efficient fracture conductivity. It is to be appreciated that while the present disclosure refers to a single particulate of petroleum coke, a plurality of petroleum coke particles and/or fines may be bound together using the resin coating described herein to form a single proppant, particulate, provided that the various specification elements described herein are met.

The resin for coating the petroleum coke proppant particulates may include, but are not limited to, an epoxy, a methacrylate, a polyester, a vinyl ester, a furan, a furfural, an alcohol-furfural, a polyurethane, a urea-aldehyde, a phenol-aldehyde, and the like, and any combination thereof. Accordingly, in some aspects, the resin has a density in the range of 1.0 g/cc to 1.7 g/cc, or 1.0 g/cc to 1.6 g/cc, or 1.0 g/cc to 1.4 g/cc, encompassing any value and subset therebetween.

In some or all aspects, the resin may be cured using heat, a curing agent, or a combination thereof depending on the particular resin selected, among other factors. Suitable curing agents may include, but are not limited to, an amine, a polyamine, an organochlorine, an amide, a polyamide, a mercaptan, and the like, and any combination thereof.

In one or more aspects of the present disclosure, the surface coating thickness of the resin coating upon the petroleum coke proppant particulates may be in the range of about 5μm to about 20 μm, or 5μm to 10 μm, or 10 μm to 20 μm, as measured at the thickest coating location, encompassing any value and subset therebetween. The particular thickness may depend on a number of factors including, but not limited to, the composition of the petroleum coke proppant particulate, the composition of the resin (and any additives), the desired density, the desired crush strength, the composition of the subterranean formation, and the like, and any combination thereof. The thickness should be selected such that the average diameter of the resin-coated petroleum coke proppant particulates meets the average diameter range described above for the uncoated petroleum coke proppant particulates.

Due to a relatively thin coating layer, the resin-coated petroleum coke proppant particulates of the present disclosure have a particle density close to the density of uncoated petroleum coke, equal to or less than 1.7 g/cc. In some aspects, the particle density of the resin-coated petroleum coke proppant particulates is in the range of 1.4 g/c to 1.7 g/cc, such as 1.4 g/cc to 1.6 g/cc, or 1.4 g/cc to 1.5 g/cc, or 1.5 g/cc to 1.6 g/cc, or 1.5 g/cc to 1.7 g/cc, or 1.6 g/cc to 1.7 g/cc, encompassing any value and subset therebetween. Moreover, as described in greater detail below, the density of the carrier fluids for use in the embodiments of the present disclosure (e.g., slickwater) may be in the range of 1.0 g/cc to 1.5 g/cc, or 1.0 g/cc to 1.2 g/cc, encompassing any value and subset therebetween. Accordingly, the resin-coated petroleum coke proppant particulates also have a density closer to the desired carrier fluid compared to traditional sand proppant particulates and will, therefore, exhibit better suspension for this reason, as well.

The resin-coated petroleum coke proppant particulates may be substantially spherical and round in shape. Accordingly, in one or all aspects of the present disclosure, the sphericity of the resin-coated petroleum coke proppant particulates are in the range of 0.6 to 1.0, such as 0.6 to 0.8, or 0.8 to 1.0, encompassing any value and subset therebetween. The roundness of the resin-coated petroleum coke proppant particulates of the present disclosure are in the range of 0.6 to 1.0, such as 0.6 to 0.8, or 0.8 to 1.0, encompassing any value and subset therebetween.

The resin-coated petroleum coke proppant particulates described herein may be used as part of a fracturing fluid for use in a hydraulic fracturing operation, the fracturing fluid comprising a flowable (e.g., liquid or gelled) carrier fluid (which may or may not be mixed with sand proppant particulates) and one or more optional additives. This fracturing fluid can be formulated at the well site in a mixing process that is conducted while it is being pumped. When the fracturing fluid is formulated at the well site, resin-coated petroleum coke proppant particulates can be added in a manner similar to the known methods for adding traditional proppant particulates (e.g., sand) into the fracturing fluid, as described in greater detail below.

The carrier fluid of the present disclosure may comprise an aqueous-based fluid or a nonaqueous-based fluid. Aqueous-based fluids may include, but are not limited to, fresh water, saltwater (including seawater), treated water (e.g., treated production water), other forms of aqueous fluid, and any combination thereof. Nonaqueous-based fluids may include, for example, supercritical carbon-dioxide, liquid nitrogen, oil-based fluids (e.g., hydrocarbon, olefin, mineral oil, fatty acid), alcohol-based fluids, and any combination thereof.

One aqueous-based fluid class referred to as slickwater can be used with the low density resin-coated petroleum coke proppant particulates of the present disclosure. Slickwater aqueous-based fluids have a relatively low viscosity of generally less than 100 centipoise (0), or in the range of 3 cP to 100 cP, such as 10 cP to 50 cP, or 10 cP to 25 cP, or 25 cP to 50 cP, encompassing any value and subset therebetween, and have low densities in the in the range of 1.0 g/cc to 1.5 g/cc, or 1.0 g/cc to 1.2 g/cc, encompassing any value and subset therebetween. As such, and unlike traditional high density proppant particulates, the resin-coated petroleum coke proppant particulates suspended in a slickwater carrier fluid, whether additional additives are included or not, can be pumped at high flow rates, and thus at high turbulence, to facilitate fracturing while maintaining the resin-coated petroleum coke proppant particulates in suspension.

In various aspects, the viscosity and density of the carrier fluid may be altered by foaming or gelling. Foaming may be achieved using, for example, air or other gases (e.g., CO₂, N₂), alone or in combination. Gelling may be achieved using, for example, guar gum (e.g., hydroxypropyl guar), cellulose, or other gelling agents, which may or may not be crosslinked using one or more crosslinkers, such as polyvalent metal ions or borate anions, among other suitable crosslinkers. It is to be noted, however, that because the resin-coated petroleum coke proppant particulates of the present disclosure exhibit particularly low density, the carrier fluid can be void of foaming or gelling agents or may otherwise comprise a reduced amount of foaming or gelling agents compared to a carrier fluid comprising traditional proppant particulates.

In addition, the carrier fluids may comprise one or more additives such as, for example, dilute aids, biocides, breakers, corrosion inhibitors, crosslinkers, friction reducers (e.g., polyacrylamides), gels, salts (e.g., KCl), oxygen scavengers, pH control additives, scale inhibitors, surfactants, weighting agents, inert solids, fluid loss control agents, emulsifiers, emulsion thinners, emulsion thickeners, viscosifying agents, particles, lost circulation materials, buffers, stabilizers, chelating agents, mutual solvents, oxidizers, reducers, clay stabilizing agents, and any combination thereof.

The methods described herein include preparation of fracturing fluid, which is not considered to be particularly limited, because the resin-coated petroleum coke proppant particulates are capable of transportation in dry form or as part of a wet slurry from a manufacturing site (e.g., a refinery or synthetic fuel plant). Dry and wet forms may be transported via truck or rail, and wet forms may further be transported via pipelines. The transported dry or wet form of the resin-coated petroleum coke proppant particulates may be added to a carrier fluid, including optional additives, at a production site, either directly into a wellbore or by pre-mixing in a hopper or other mixing equipment. In some aspects, for example, when the entirety of the proppant particulates within the fracturing fluid at a given time resin-coated petroleum coke proppant particulates, slugs of the dry or wet form may be added directly to the fracturing fluid (e.g., as it is introduced into the wellbore). These slugs of only resin-coated petroleum coke coated proppant particulates may be followed by subsequent slugs of, again, resin-coated petroleum coke coated proppant particulates or of a mixture of resin-coated petroleum coke coated proppant particulates and other traditional proppant particulates. In other aspects, such as when other traditional proppant particulate types are combined with the resin-coated petroleum coke coated proppant particulates, a portion or all of the fracturing fluid may be pre-mixed at the production site or each proppant type may be added directly to the fracturing fluid separately or simultaneously. Any other suitable mixing or adding of the resin-coated petroleum coke proppant particulates to produce a desired fracturing fluid composition may also be used, without departing from the scope of the present disclosure.

The methods of hydraulic fracturing suitable for use in one or more aspects of the present disclosure involve pumping fracturing fluid comprising resin-coated petroleum coke proppant particulates at a high pump rate into a subterranean formation to form at least a primary fracture, as well as potentially one or more secondary fractures extending from the primary fracture, one or more tertiary fractures extending from the secondary fractures, and the like (all collectively referred to as a “fracture”). In an embodiment, this process is conducted one stage at a time along a horizontal well. The stage is hydraulically isolated from any other stages which have been previously fractured. In one embodiment, the stage being fractured has clusters of perf holes (e.g., perforations in the wellbore and/or subterranean formation) allowing flow of hydraulic fracturing fluid through a metal tubular casing of the horizontal well into the formation. Such metal tubular casings are installed as part of the completions when the well is drilled and serve to provide mechanical integrity for the horizontal wellbore. In some aspects, the pump rate for use during hydraulic fracturing may be at least about 10 barrels per minute (bbl/min), or at least about 30 bbl/min, and more in excess of about 50 bbl/min and less than 200 bbl/min at one or more time durations during the fracturing operation (e.g., the rate may be constant, steadily increased, or pulsed), encompassing any value and subset therebetween. These high rates may, in some aspects, be utilized after about 10% of the entire volume of fracturing fluid to be pumped into the formation has been injected. That is, at the early periods of a hydraulic fracturing operation, the pump rate may be lower and as fracture(s) begin to form, the pump rate may be increased. Generally, the average pump rate of the fracturing fluid throughout the operation may be about 10 bbl/min, or about 15 bbl/min, or about 25 bbl/min. Typically, the pump rate during a fracturing operation may be, at any one time, in the range of about 20 bbl/min to about 150 bbl/min, or about 40 bbl/min to about 120 bbl/min, or about 40 bbl/min to about 100 bbl/min, encompassing any value and subset therebetween.

In various aspects, the methods of hydraulic fracturing described herein may be performed wherein the concentration of the proppant particulates (including resin-coated petroleum coke proppant particulates and any other traditional proppant particulates) within the injected fracturing fluid is altered (i.e., on-the-fly while the fracturing operation is being performed, such that hydraulic pressure is maintained within the formation and fracture(s)). For example, in some aspects, the initially injected fracturing fluid may be injected at a low pump rate and may comprise proppant particulates in an amount of 0 volume % (vol %) to about 1 vol % of the fracturing fluid. As one or more fractures begin to form and grow, the pump rate is increased and the concentration of proppant particulates may be increased in a stepwise fashion (with or without a stepwise increase in pump rate) with a maximum concentration of proppant particulates reaching about 2.5 vol % to about 20 vol % of the fracturing fluid, encompassing any value and subset therebetween, which may be solely resin-coated petroleum coke proppant particulates. For example, the maximum concentration of proppant particulates may reach at least 2.5 vol %, or at least about 8 vol %, or at least about 16 vol % of the fracturing fluid. In some aspects, all of the proppant particulates are resin-coated petroleum coke proppant particulates. In other aspects, at one or more time periods during the hydraulic fracturing operation, at least about 2 vol % to about 100 vol % of any proppant particulates suspended within the fracturing fluid are resin-coated petroleum coke proppant particulates, such as at least about 2 vol %, or at least about 15 vol %, or at least about 25 vol %, or 100 vol %, or in the range of about 20 vol % to about 50 vol %, encompassing any value and subset therebetween. When the resin-coated petroleum coke proppant particulates are included in fracturing fluid with other proppant particulates, it is expected that at least about 5 vol % to about 50 vol %, such as about 25 vol % to about 50 vol % of any proppant particulates will be the resin-coated petroleum coke proppant particulates, encompassing any value and subset therebetween. Moreover, when combined the average diameters of any proppant particulates may be the same or different, without departing from the scope of the present disclosure.

In one or more aspects, the resin-coated petroleum coke proppant particulates may be introduced into a stage at an early time during the particular pumping design (i.e., an early phase during pumping within a particular stage). For example, the resin-coated petroleum coke proppant particulates may be introduced in a pre-pad fracturing fluid comprising a slickwater carrier fluid designed to fill the well and initiate one or more fractures. As such, the resin-coated petroleum may be introduced into the fractures at an early stage and thereafter continuously pushed toward far-field areas of the fractures as they continue to grow in later pumping phases. In such instances, it is desirable that all of the proppant particulates in the pre-pad are lightweight proppant particulates, such is resin-coated petroleum coke.

In additional aspects, the resin-coated petroleum coke proppant particulates may be introduced after about ⅛ to about ¾ of the total volume of fracturing fluid has been injected within a formation. Because of the low density of the resin-coated petroleum coke proppant particulates, additional introduction of the resin-coated petroleum coke proppant particulates during later time periods up to and including completion of fracturing after which the fracture(s) have already grown substantially, such that the resin-coated petroleum coke proppant particulates can travel within the fracturing fluid to remote locations of the formed fracture(s) between interstitial areas that denser proppant particulates would not be able to reach due to settling effects, for example. In these later stages, the resin-coated petroleum coke proppant particulates may be mixed with other proppant particulates, such as traditional (e.g., sand) proppant particulates. It is expected that, when included, at least about 5 to about 10 vol % to about 90 vol % of any proppant particulates will be the resin-coated petroleum coke proppant particulates, encompassing any value and subset therebetween.

The hydraulic fracturing methods described herein may be performed in drilled horizontal, vertical, or tortuous wellbores, hydrocarbon-producing (e.g., oil and/or gas) wellbores and water-producing wellbores. These wellbores may be in various subterranean formation types including, but not limited to, shale formations, oil sands, gas sands, and the like.

The wellbores are typically completed using a metal (e.g., steel) tubular or casing that is cemented into the subterranean formation. To contact the formation, a plurality of perforations are created through the tubular and cement along a section to be treated, usually referred to as a plug and perforated (“plug and perf”) cased-hole completion. Alternative completion techniques may be used without departing from the scope of the present disclosure, but in each technique, a finite length of the wellbore is exposed for hydraulic fracturing and injection of fracturing fluid. This finite section is referred to herein as a “stage.” In plug and perf completions, the stage length may be based a distance over which the tubular and cement has been perforated, and may be in the range of about 10 feet (ft) to about 2000 ft, for example, and more generally in the range of about 100 ft to about 300 ft, encompassing any value and subset therebetween. The stage is isolated (e.g., sliding sleeve, ball) such that pressurized fracturing fluid from the surface can flow through the perforations and into the formation to generate one or more fractures in only the stage area. Clusters of perforations may be used to facilitate initiation of multiple fractures. For example, clusters of perforations may be made in sections of the stage that are about 1 ft to about 3 ft in length, and spaced apart by about 2 ft to about 100 ft, encompassing any value and subset therebetween.

For each linear foot of the stage, at least about 6 barrels (about 24 cubic feet (ft³)), or at least about 24 barrels (about 135 ft³), or at least 60 barrels (about 335 ft³) and less than 6000 barrels (about 33,500 ft³) of fracturing fluid may be injected to grow the one or more fractures, encompassing any value and subset therebetween. In certain aspects, for each linear foot of the stage, at least about 1.6 ft³, preferably about 6.4 ft³, and more preferably at least 16 ft³ and less than 1600 ft³ of proppant particulates may be injected to prop the fractures. In some aspects, to prevent bridging of the proppant particulates during injection into the fractures, the ratio of the volume of the proppant particulates to the liquid portion of the fracturing fluid, primarily the carrier fluid, is greater than 0 and less than about 0.25 and preferably less than about 0.15. If the volume ratio becomes too large a phenomena known as “sanding out” will occur.

Certain commercial operations, such as commercial shale fracturing operations, may be particularly suitable for hydraulic fracturing using the resin-coated petroleum coke proppant particulates and methods described herein, as the mass of proppant particulates required per stage in such operations can be quite large and substantial economic benefit may be derived using the resin-coated petroleum coke proppant particulates. Indeed, in some instances, a stage in a shale formation may be designed to require at least about 30,000, at least about 100,000, or at least about 250,000 pounds (mass) of proppant particulates, encompassing any value and subset therebetween. In such cases, economic and performance benefit may be optimized when at least about 5%, or at least about 25%, and up to 100% of the proppant particulate mass comprises resin-coated petroleum coke proppant particulates.

Multiple stages of the wellbore are isolated and hydraulic fracturing performed at each stage. The resin-coated petroleum coke proppant particulates of the present disclosure may be used in any one, more, or all stages, including at least 2 stages, at least 10 stages, or at least 20 stages.

### Exemplary Embodiments

Nonlimiting example embodiments of the present disclosure include the following.

Embodiment A: A proppant particulate comprising: a petroleum coke particle composed of fluid coke or flexicoke; and a resin coating at least a portion of the petroleum coke particle.

Embodiment B: A fracturing fluid comprising: a carrier fluid; and proppant particulates comprising a petroleum coke particle composed of fluid coke or flexicoke and a resin coating at least a portion of the petroleum coke particle.

Embodiment C: A method comprising: introducing a fracturing fluid into a subterranean formation, the fracturing fluid comprising: a carrier fluid; and proppant particulates comprising a petroleum coke particle and a resin coating at least a portion of the petroleum coke particle.

Nonlimiting example embodiments A, B, or C may include one or more of the following elements.

Element 1: Wherein the proppant particulate has a particle density of equal to or less than about 1.7 grams per cubic centimeter.

Element 2: Wherein the resin coating is a surface coating of at least a portion of the petroleum coke particle, an embedment coating within pores of the petroleum coke particle, and any combination thereof.

Element 3: Wherein the resin coating is a surface coating having a thickness in the range of about 5 micrometers to about 20 micrometers.

Element 4: Wherein the particle density is in the range of about 1.4 grams per cubic centimeter to about 1.7 grams per cubic centimeter.

Element 5: Wherein the petroleum coke particle is fluid coke.

Element 6: Wherein the petroleum coke particle is flexicoke.

Element 7: Wherein the resin coating is an epoxy, a methacrylate, a polyester, a vinyl ester, a furan, a furfural, an alcohol-furfural, a polyurethane, a urea-aldehyde, a phenol-aldehyde, and any combination thereof.

Element 8: Wherein the resin coating has a density in the range of about 1.0 grams per cubic centimeter to about 1.7 grams per cubic centimeter.

Element 9: Wherein the resin coating further comprises a curing agent.

Element 10: Wherein the resin coating further comprises a curing agent, and wherein the curing agent is an amine, a polyamine, an organochlorine, an amide, a polyamide, a mercaptan, and any combination thereof.

Element 11: Wherein the proppant particulate has an average diameter in the range of about 65 micrometers to about 600 micrometers.

Element 12: Wherein the proppant particulate has a Krumbein sphericity of ≥0.6.

Element 13: Wherein the petroleum coke particle is composed of a plurality of petroleum coke fines.

Nonlimiting example embodiments B or C may include one or more of the following elements:

Element 14: Wherein the carrier fluid is an aqueous carrier fluid.

Element 15: Wherein the carrier fluid is a slickwater.

Element 16: Further comprising second proppant particulates composed of a material that is not a resin-coated petroleum coke material.

Nonlimiting example embodiment C may include one or more of the following elements:

Element 17: Further comprising depositing at least a portion of the proppant particulates within one or more fractures in the subterranean formation.

Unless otherwise indicated, all numbers expressing quantities of ingredients, properties such as molecular weight, reaction conditions, and so forth used in the present specification and associated claims are to be understood as being modified in all instances by the term “about,” and take into account experimental error and variations that would be expected by a person having ordinary skill in the art. Accordingly, unless indicated to the contrary, the numerical parameters set forth in the following specification and attached claims are approximations that may vary depending upon the desired properties sought to be obtained by the incarnations of the present inventions. At the very least, and not as an attempt to limit the application of the doctrine of equivalents to the scope of the claim, each numerical parameter should at least be construed in light of the number of reported significant digits and by applying ordinary rounding techniques.

One or more illustrative incarnations incorporating one or more invention elements are presented herein. Not all features of a physical implementation are described or shown in this application for the sake of clarity. It is understood that in the development of a physical embodiment incorporating one or more elements of the present invention, numerous implementation-specific decisions must be made to achieve the developer's goals, such as compliance with system-related, business-related, government-related and other constraints, which vary by implementation and from time to time. While a developer's efforts might be time-consuming, such efforts would be, nevertheless, a routine undertaking for those of ordinary skill in the art and having benefit of this disclosure.

While compositions and methods are described herein in terms of “comprising” various components or steps, the compositions and methods can also “consist essentially of” or “consist of” the various components and steps.

Accordingly, the resin-coated petroleum coke proppant particulates of the present disclosure are suitable for use in fracturing operations, including in unconventional formation types.

Many alterations, modifications, and variations will be apparent to those skilled in the art in light of the foregoing description without departing from the spirit or scope of the present disclosure and that when numerical lower limits and numerical upper limits are listed herein, ranges from any lower limit to any upper limit are contemplated.

Therefore, the present disclosure is well adapted to attain the ends and advantages mentioned as well as those that are inherent therein. The particular examples and configurations disclosed above are illustrative only, as the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative examples disclosed above may be altered, combined, or modified and all such variations are considered within the scope and spirit of the present disclosure. The embodiments illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

What is claimed is:

1. A proppant particulate comprising:
a petroleum coke particle composed of fluid coke or flexicoke; and
a resin coating at least a portion of the petroleum coke particle.

2. The proppant particulate of claim 1, wherein the proppant particulate has a particle density of equal to or less than about 1.7 grams per cubic centimeter.

3. The proppant particulate of claim 1, wherein the resin coating is a surface coating of at least a portion of the petroleum coke particle, an embedment coating within pores of the petroleum coke particle, and any combination thereof.

4. The proppant particulate of claim 1, wherein the resin coating is a surface coating having a thickness in the range of about 5 micrometers to about 20 micrometers.

5. The proppant particulate of claim 1, wherein the particle density is in the range of about 1.4 grams per cubic centimeter to about 1.7 grams per cubic centimeter.

6. The proppant particulate of claim 1, wherein the petroleum coke particle is fluid coke.

7. The proppant particulate of claim 1, wherein the petroleum coke particle is flexicoke.

8. The proppant particulate of claim 1, wherein the resin coating is an epoxy, a methacrylate, a polyester, a vinyl ester, a furan, a furfural, an alcohol-furfural, a polyurethane, a urea-aldehyde, a phenol-aldehyde, and any combination thereof.

9. The proppant particulate of claim 1, wherein the resin coating has a density in the range of about 1.0 grams per cubic centimeter to about 1.7 grams per cubic centimeter.

10. The proppant particulate of claim 1, wherein the resin coating further comprises a curing agent.

11. The proppant particulate of claim 10, wherein the curing agent is an amine, a polyamine, an organochlorine, an amide, a polyamide, a mercaptan, and any combination thereof.

12. The proppant particulate of claim 1, wherein the proppant particulate has an average diameter in the range of about 65 micrometers to about 600 micrometers.

13. The proppant particulate of claim 1, wherein the proppant particulate has a Krumbein sphericity of ≥0.6.

14. The proppant particulate of claim 1, wherein the proppant particulate has a Krumbein roundness value of ≥0.6.

15. The proppant particulate of claim 1, wherein the petroleum coke particle is composed of a plurality of petroleum coke fines.

16. A fracturing fluid comprising:
a carrier fluid; and
proppant particulates comprising a petroleum coke particle composed of fluid coke or flexicoke and a resin coating at least a portion of the petroleum coke particle.

17. The fracturing fluid of claim 16, wherein the proppant particulates have a particle density of equal to or less than 1.7 grams per cubic centimeter.

18. The fracturing fluid of claim 16, wherein the carrier fluid is an aqueous carrier fluid.

19. The fracturing fluid of claim 16, wherein the carrier fluid is a slickwater.

20. The fracturing fluid claim 16, further comprising second proppant particulates composed of a material that is not a resin-coated petroleum coke material.

21. A method comprising:
introducing a fracturing fluid into a subterranean formation, the fracturing fluid comprising:
a carrier fluid; and
proppant particulates comprising a petroleum coke particle and a resin coating at least a portion of the petroleum coke particle.

22. The method of claim 21, wherein the proppant particulates have a particle density of equal to or less than 1.7 grams per cubic centimeter.

23. The method of claim 21, further comprising depositing at least a portion of the proppant particulates within one or more fractures in the subterranean formation.

24. The method of claim 21, wherein the fracturing fluid further comprises second proppant particulates composed of a material that is not a resin-coated petroleum coke material.
